(19) United States
(12) Patent Application Publication
(10) Pub. No.: US 2021/0262608 A1
(43) Pub. Date: Aug. 26, 2021

(54) AUTOMATIC PHOTOGRAPHING DEVICE AND SELF-SERVICE PHOTOGRAPHING MACHINE

(71) Applicant: Siming CAO, Shenzhen (CN)

(72) Inventor: Siming CAO, Shenzhen (CN)

(21) Appl. No.: 17/317,388

(22) Filed: May 11, 2021

Related U.S. Application Data
(63) Continuation of application No. PCT/CN2019/115490, filed on Nov. 5, 2019.

(30) Foreign Application Priority Data
Nov. 22, 2018 (CN) 201811398347.0

(51) Int. Cl. F16M 11/06; H04N 5/225; F16M 11/42; G03B 17/56

(52) U.S. Cl. CPC F16M 11/06; H04N 5/225; F16M 2200/00; G03B 17/566; F16M 11/425

(57) ABSTRACT

The present application provides an automatic photographing device and a self-service photographing machine, including a camera, a vertical guide rail, a slider adapted to the guide rail and a support plate with one end connected with the slider. The slider is provided with a drive mechanism, the other end of the support plate is provided with a horizontal rotation mechanism, the horizontal rotation mechanism is provided with a pitch rotation mechanism, the pitch rotation mechanism is provided with a bracket, and the camera is connected with the bracket through a turning mechanism. The present application can help people to shoot more professional photos with multiple angles and styles, and the photographed photos are more natural and beautiful, meanwhile, the shooting efficiency is improved, and the different needs of photographers are greatly met.

### CROSS-REFERENCE TO RELATED APPLICATIONS

The present application is a continuation application of PCT Application No. PCT/CN2019/115490, filed on Nov. 5, 2019, which claims priority to Chinese Patent Application No. 201811398347.0, filed on Nov. 22, 2018. The disclosures of the aforementioned applications are hereby incorporated by reference in their entireties.

### TECHNICAL FIELD

The present application relates to the field of photography, in particular to an automatic photographing device and a self-service photographing machine.

### BACKGROUND

Nowadays a photographing device is usually equipped in a subway station or an accreditation hall, for people to take pictures by themselves. But at present, most of the photographing devices are used to take ID photos. With the development of Internet, people are more and more fond of taking selfies and sending the selfies to the WeChat Moments or Weibo through the network. Most of the photographing devices are mobile phones. However, due to limitations of technology, the front-facing cameras used to take selfies on mobile phones are usually low-resolution, when to take a photo with a mobile phone, because the handheld distance is relatively close, only the upper bodies can be photographed, and when to take photos with friends, the number of people cannot be too large, thus it is far from meeting the needs of modern people.

### SUMMARY

In order to solve the problems in the prior art, the present application provides an automatic photographing device and a self-service photographing machine capable of photographing with high-definition effects and at various angles.

The present application provides an automatic photographing device, which includes a camera, a vertical guide rail, a slider adapted to the guide rail and a support plate with one end connected with the slider, the slider is provided with a drive mechanism, the other end of the support plate is provided with a horizontal rotation mechanism, the horizontal rotation mechanism is provided with a pitch rotation mechanism, the pitch rotation mechanism is provided with a bracket, and the camera is connected with the bracket through a turning mechanism.

As a further improvement of the present application, the horizontal rotation mechanism includes a horizontal rotation motor fixed on the support plate and a horizontal rotation adjustment plate fixedly connected with an output end of the horizontal rotation motor, and the pitch rotation mechanism is fixed on the horizontal rotation adjustment plate.

As a further improvement of the present application, the pitch rotation mechanism includes a pitch rotation motor fixed on the horizontal rotation adjustment plate and a pitch rotation adjustment plate fixedly connected with an output end of the pitch rotation motor, and the bracket is fixed on the pitch rotation adjustment plate.

As a further improvement of the present application, the turning mechanism includes a turning motor fixed on the bracket and a fix ring mounted on the camera, a drive gear is arranged at an output end of the turning motor, a periphery of the fix ring is provided with a driven gear ring meshed with the drive gear, the bracket includes a first support ring and a second support ring for supporting the camera, an inner side of the first support ring is provided with a first rotation stop ring, and an inner side of the second support ring is provided with a second rotation stop ring.

The present application also discloses a self-service photographing machine, which includes a machine body and the automatic photographing device, the machine body includes a photographing accommodating cavity arranged on one side, the automatic photographing device is arranged in the photographing accommodating cavity, and the machine body further includes a main control board electrically connected with the automatic photographing device and a primary display, a photo printer, a wireless transmission unit and a power supply electrically connected with the main control board.

As a further improvement of the present application, a bellows is hinged on one side of the machine body, and the bellows is provided with a plurality of fans arranged longitudinally, and the fans are electrically connected with the main control board.

As a further improvement of the present application, an upper end of the machine body is configured with a laser projection head, a front part of the machine body is configured with a fill light, a secondary display screen, a shutter button, a coin slot and a quick response code scanning port, and the machine body is further configured with a sound electrically connected with the main control board.

As a further improvement of the present application, a canopy is arranged above the machine body, a reflector is arranged on a lower surface of a front end of the canopy, a solar panel electrically connected with the main control board is laid on an upper surface of the canopy, and the power supply is a storage battery.

As a further improvement of the present application, the machine body is further configured with a selling window and a delivery port.

As a further improvement of the present application, the machine body is further configured with a prop storage port.

The present application has the beneficial effects that the present application can help people to shoot more professional photos with multiple angles and styles, and the photographed photos are more natural and beautiful, meanwhile, the shooting efficiency is improved, and the different needs of photographers are greatly met.

### BRIEF DESCRIPTION OF THE DRAWINGS

FIG. 1 is a schematic structural view of an automatic photographing device of the present application.

FIG. 2 is a schematic structural view of FIG. 1 from another perspective.

FIG. 3 is a schematic structural view of an overall structure of a self-service photographing machine of the present application.

### DETAILED DESCRIPTION OF THE EMBODIMENTS

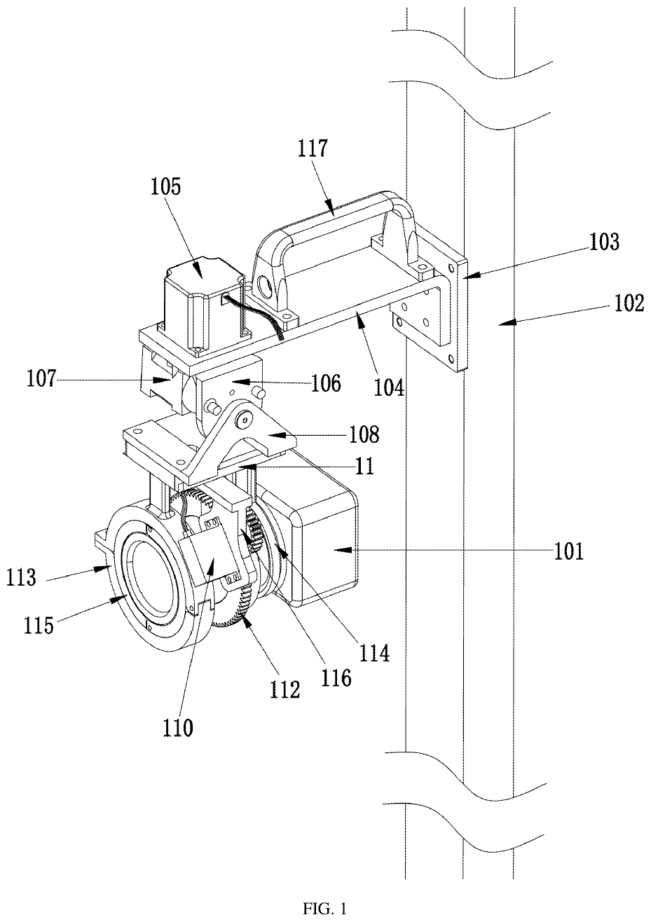

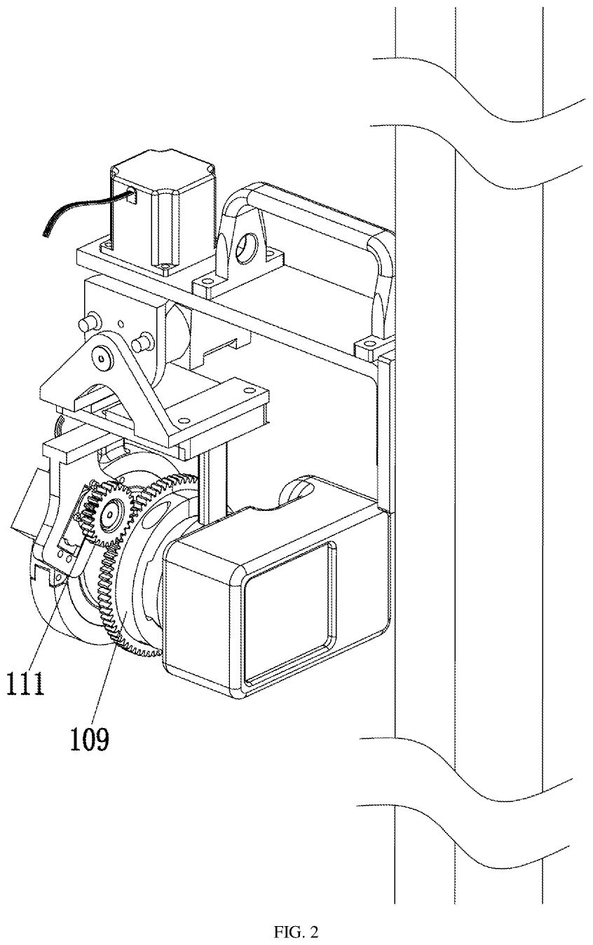

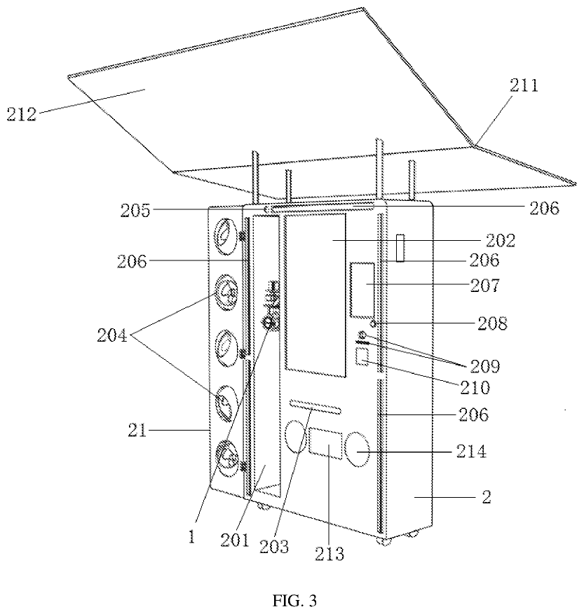

As shown in FIGS. 1 to 3, the present application discloses an automatic photographing device, which includes a camera 101, an upright guide rail 102, a slider 103 adapted to the guide rail 102 and a support plate 104 with one end connected to the slider 103. A low end of the guide rail 102 is provided with a base to support the guide rail 10. The slider 103 is provided with a drive mechanism, so that the slider 103 can slide up and down on the guide rail 102. In this embodiment, the drive mechanism of the slider 103 is a drive motor that drives a drive chain to drive the slide block 103 to slide on the guide rail 102. The drive mode is simple. A horizontally rotation mechanism is provided at the other end of the support plate 104, The horizontally rotation mechanism is provided with a pitch rotation mechanism. The pitch rotation mechanism is provided with a bracket 11. The camera 101 is connected to the bracket 11 through a turning mechanism. In this way, the camera 101 can be turned relative to the bracket 11 by the turning mechanism, thereby changing the camera 101 to the horizontal shot or the vertical shot. The bracket 11 changes the pitch shooting angle of the camera 101 by a pitch rotation mechanism. The pitch rotation mechanism changes the shooting angle of the camera 101 in the horizontal direction by the horizontal rotation mechanism. The horizontal rotation mechanism changes a position of the camera 101 in an up and down direction by being driven by the support plate 104, To meet the requirements of different heights. The automatic photographing device 1 can take photographs at multiple angles, which is more in line with the photographing requirements of modern people, and the photographing effect is more colorful. The automatic photographing device 1 also includes a controller for controlling the position or angle adjustment of each mechanism.

In this embodiment, the horizontal rotation mechanism includes a horizontal rotation motor 105 fixed on the support plate 104 and a horizontal rotation adjustment plate 106 fixedly connected with an output end of the horizontal rotation motor 105. The pitch rotation mechanism is fixed on the horizontal rotation adjustment plate 106, and the horizontal rotation motor 105 can drive the horizontal rotation adjustment plate 106 to rotate in a horizontal direction, thereby driving the pitch rotation mechanism to rotate left and right.

In this embodiment, the pitch rotation mechanism includes a pitch rotation motor 107 fixed on the horizontal rotation adjustment plate 106 and a pitch rotation adjustment plate 108 fixedly connected with an output end of the pitch rotation motor 107. The bracket 11 is fixed on the pitch rotation adjustment plate 108, and set directions of the pitch rotation motor 107 and the horizontal rotation motor 105 are perpendicular to each other. The pitch rotation motor 107 can drive the bracket 11 to rotate in a vertical direction, thereby adjusting the pitch shooting angle of the camera 101.

In this embodiment, the turning mechanism includes a turning motor 110 fixed to the bracket 11 through a turning bracket 116 and a fix ring 109 mounted on the camera 101. A drive gear 111 is provided at an output end of the turning motor 110. A periphery of the fix ring 109 is provided with a driven gear ring 112 meshing with the driving gear 111. The camera 101 is a single lens reflex (SLR) camera 101 or another type of camera. The bracket includes a first support ring 113 for supporting a front end of the camera 101 and a second support ring 114 for supporting a rear end of the camera 101, An inner side of the first support ring 113 is provided with a first rotation stop ring 115. The camera 101 is fixed in the first rotation stop ring 115 and the second rotation stop ring 115. When the turning motor 110 works, the driving gear 111 drives the driven gear ring 112 to rotate, thereby driving the camera 101 to turn over to change the camera 101 to the horizontal shot or the vertical shot.

The present application also discloses a self-service photographing machine, which includes a machine body and the automatic photographing device. The machine body 2 includes a photographing accommodating chamber 201 provided on one side. The automatic photographing device 1 is disposed in the photographing accommodating chamber 201. A protective glass of high light transmittance is provided outside of the photographing accommodating chamber 201. The machine body 2 further includes a main control board electrically connected with the controller of the automatic photographing device 1, and a primary display 202, a photo printer 203, a wireless transmission unit and a power supply all electrically connected with the main control board. The primary display 202 is configured for displaying real-time images taken by the camera, later photos and an operating system interface. The primary display 202 has a touch function. The photo printer 203 is capable of printing photos, and output the printed photos through a printing outlet arranged on the machine body 2. Or the automatic photographing device is connected with mobile terminals such as mobile phones through the wireless transmission unit. Electronic documents of photos are directly sent to the mobile terminals, and through the wireless transmission unit, the automatic photographing device 1 can also be controlled after being paired with a mobile phone in a wireless manner, thereby facilitating self-photographing. The power supply supplies power to the whole equipment, and the wireless transmission unit can be arranged on the automatic photographing device.

In this embodiment, a bellows 21 is hinged on one side of the machine body 2. The bellows 21 is provided with a plurality of fans 204 arranged longitudinally, and the fans 204 are electrically connected with the main control board. By arranging the bellows 21, people who take selfies can be given some air, so that more shapes can be added, which is more in line with the photographing requirements of modern people. The bellows 21 is hinged with the machine body 2, so that an angle of the air can be adjusted, and the shaping effect can be further enhanced.

In this embodiment, a lase projection head 205 is provided at an upper end of the machine body 2. The lase projection head 205 can mark the best position of the subject on the ground with visible laser. A fill light 206, a secondary display screen 207, a shutter button 208, a coin slot 209 and a quick response (QR) code scanning port 210 are provided at the front of the machine body 2. The fill light 206 can serve for light supplement, to make the shooting more clearly. The secondary display screen 207 can display a photo qualification template and a payment QR code, and the secondary display screen 207 also has a touch function. The shutter button 208 is a physical shutter button, which can facilitate others to help shoot. The coin slot 209 and the QR code scanning port 210 are both for payment. The machine body 2 is also provided with a sound 214 electrically connected with the main control board and capable of performing voice prompt or music play.

In this embodiment, a canopy 211 is arranged above the machine body 2. A front end of the canopy 211 can be tilted upward for a certain angle. A lower surface of the canopy 211 is provided with a reflector 212, which can supplement light during backlighting shooting, and the canopy 211 is inclined downward for a certain angle under normal circumstances, and is configured for shading sun and preventing rain. An upper surface of the canopy 211 is paved with a solar panel electrically connected with the main control board, and the power supply is a storage battery, so that the storage battery can be charged by the solar panel.

In this embodiment, the machine body 2 is also provided with a selling window and a delivery port 213, similar to a vending machine, and convenient for people to buy drinks or small ornaments which can enhance the shooting effect.

In this embodiment, the machine body 2 is also provided with a prop storage port, which is arranged on one side of the machine body 2 and can contain some props for taking pictures.

In this embodiment, an upper end of the support plate 104 is also provided with a handle 117, which is convenient for the camera 101 to test and carry.

The self-service photographing machine can take photos of different angles and styles according to the needs of photographers, greatly meeting the selfie needs of modern people, and it is simple and convenient to operate. The self-service photographing machine has strong mobility and can be placed in parks, shopping malls or pedestrian streets, thus greatly facilitating the use needs of people.

The above is a further detailed description of the present application in connection with specific exemplary embodiments, and it cannot be considered that the specific implementation of the present application is limited to these descriptions. To one of ordinary skill in the art to which the present application belongs, a number of simple deductions or alternatives can be made without departing from the concept of the present application, which should be regarded as falling within the scope of the present application.

What is claimed is:

1. An automatic photographing device, comprising a camera, a vertical guide rail, a slider adapted to the guide rail and a support plate with one end connected with the slider,
wherein the slider is provided with a drive mechanism, the other end of the support plate is provided with a horizontal rotation mechanism, the horizontal rotation mechanism is provided with a pitch rotation mechanism, the pitch rotation mechanism is provided with a bracket, and the camera is connected with the bracket through a turning mechanism.

2. The automatic photographing device according to claim 1, wherein the horizontal rotation mechanism comprises a horizontal rotation motor fixed on the support plate and a horizontal rotation adjustment plate fixedly connected with an output end of the horizontal rotation motor, and the pitch rotation mechanism is fixed on the horizontal rotation adjustment plate.

3. The automatic photographing device according to claim 2, wherein the pitch rotation mechanism comprises a pitch rotation motor fixed on the horizontal rotation adjustment plate and a pitch rotation adjustment plate fixedly connected with an output end of the pitch rotation motor, and the bracket is fixed on the pitch rotation adjustment plate.

4. The automatic photographing device according to claim 3, wherein the turning mechanism comprises a turning motor fixed on the bracket and a fix ring mounted on the camera, a drive gear is arranged at an output end of the turning motor, a periphery of the fix ring is provided with a driven gear ring meshed with the drive gear, the bracket comprises a first support ring and a second support ring for supporting the camera, an inner side of the first support ring is provided with a first rotation stop ring, and an inner side of the second support ring is provided with a second rotation stop ring.

5. A self-service photographing machine, comprising a machine body and the automatic photographing device according to claim 1,
wherein the machine body comprises a photographing accommodating cavity arranged on one side, the automatic photographing device is arranged in the photographing accommodating cavity, the machine body further comprises a main control board electrically connected with the automatic photographing device and a primary display, a photo printer, a wireless transmission unit and a power supply electrically connected with the main control board.

6. The self-service photographing machine according to claim 5, wherein one side of the machine body is hinged with a bellows, the bellows is provided with a plurality of fans arranged longitudinally, and the fans are electrically connected with the main control board.

7. The self-service photographing machine according to claim 5, wherein an upper end of the machine body is configured with a laser projection head, a front part of the machine body is provided with a fill light, a secondary display screen, a shutter button, a coin slot and a quick response code scanning port, and the machine body is further configured with a sound electrically connected with the main control board.

8. The self-service photographing machine according to claim 5, wherein a canopy is arranged above the machine body, a reflector is arranged on a lower surface of a front end of the canopy, a solar panel electrically connected with the main control board is laid on an upper surface of the canopy, and the power supply is a storage battery.

9. The self-service photographing machine according to claim 5, wherein the machine body is further configured with a selling window and a delivery port.

10. The self-service photographing machine according to claim 5, wherein the machine body is further configured with a prop storage port.

11. The self-service photographing machine according to claim 5, wherein the horizontal rotation mechanism comprises a horizontal rotation motor fixed on the support plate and a horizontal rotation adjustment plate fixedly connected with an output end of the horizontal rotation motor, and the pitch rotation mechanism is fixed on the horizontal rotation adjustment plate.

12. The self-service photographing machine according to claim 11, wherein the pitch rotation mechanism comprises a pitch rotation motor fixed on the horizontal rotation adjustment plate and a pitch rotation adjustment plate fixedly connected with an output end of the pitch rotation motor, and the bracket is fixed on the pitch rotation adjustment plate.

13. The self-service photographing machine according to claim 12, wherein the turning mechanism comprises a turning motor fixed on the bracket and a fix ring mounted on the camera, a drive gear is arranged at an output end of the turning motor, a periphery of the fix ring is provided with a driven gear ring meshed with the drive gear, the bracket comprises a first support ring and a second support ring for supporting the camera, an inner side of the first support ring is provided with a first rotation stop ring, and an inner side of the second support ring is provided with a second rotation stop ring.
